(19) United States
(12) Patent Application Publication
(10) Pub. No.: US 2022/0076114 A1
(43) Pub. Date: Mar. 10, 2022

(54) MODULAR-RELATED METHODS FOR MACHINE LEARNING ALGORITHMS INCLUDING CONTINUAL LEARNING ALGORITHMS

(71) Applicant: NEC Laboratories Europe GmbH, Heidelberg (DE)

(72) Inventors: Ammar Shaker, Heidelberg (DE); Shujian Yu, Heidelberg (DE); Francesco Alesiani, Heidelberg (DE)

(21) Appl. No.: 17/123,178

(22) Filed: Dec. 16, 2020

(30) Foreign Application Priority Data
Sep. 4, 2020 (EP) 20194664.7

(51) Int. Cl. G06N 3/08; G06F 17/16; G06Q 10/08; G06Q 50/30

(52) U.S. Cl. CPC G06N 3/08; G06Q 50/30; G06Q 10/08355; G06F 17/16

(57) ABSTRACT

A method for modular-based techniques for continual learning applications includes training a neural network based on learning a plurality of parameters associated with the neural network using input data associated with a current task. The neural network comprises a plurality of layers. A first layer, of the plurality of layers, comprises a plurality of nodes. Modularization of the neural network is performed to group the plurality of nodes of the first layer into at least two separate groups.

### CROSS-REFERENCE TO RELATED APPLICATION

Priority is claimed to European Patent Application No. EP20194664.7, filed on Sep. 4, 2020, the entire disclosure of which is hereby incorporated by reference herein.

### FIELD

The present invention relates to a method and system for modular-related methods for machine learning (e.g., continual learning) applications.

### BACKGROUND

Continual learning is a branch of machine learning that targets the sequential learning of tasks with the objective of learning new problems while not forgetting previously seen tasks.

Regarding sequential task learning, consider a number N of classification tasks T={Xₜ, Yₜ|t∈{1, . . . , N}}, where each task Tₜ is represented by the set of Nₜ data samples T={Xₜ, Yₜ}={(xₜᵢyₜᵢ)|i∈{1, . . . , N_t}}, xₜᵢ∈R^{p}^{ₜ} an input instance with pₜ dimensionality, while yₜᵢ∈Yₜ={c₁, . . . , cₘ_{ₜ}} is a class label taken from the mₜ unique categories. This formulation is the generic one that multi-task and continual approaches often consider. For simplicity, the setting is targeted when pₜ=p, mₜ=m, Yₜ=Y for all t∈{1, . . . , N}ₜ.

The most two popular families of continual learning are:

1) Regularization-based methods such as Elastic Weight Consolidation (EWC) (see, e.g., Kirkpatrick, J.; Pascanu, R.; Rabinowitz, N.; Veness, J.; Desjardins, G.; Rusu, A. A.; Milan, K.; Quan, J.; Ramalho, T.; Grabska-Barwinska, A.; et al. 2017. Overcoming catastrophic forgetting in neural networks. Proceedings of the national academy of sciences 114(13): 3521-3526, which is hereby incorporated by reference herein). This method proposes the Laplace approximation, the log-posterior distribution of the parameters given the tasks' data. This is further simplified by taking the precision matrix as the diagonal Fisher information matrix F_{θ}. As a result, the loss function is re-written as:

$$ℒ ( θ ) = {ℒ}_{B} ( θ ) + {\sum }_{i} \frac{λ}{2} {{ℱ}_{{θ}_{i}} ( {θ}_{i} - {θ}_{A , i}^{*} )}^{2}$$

2) Gradient-based methods try to constraint the learning in directions that are not harmful for the previous tasks, such as Gradient Episodic Memory (GEM) (see, e.g., Lopez-Paz, D.; and Ranzato, M. 2017. Gradient episodic memory for continual learning. In Advances in Neural Information Processing Systems, 6467-6476, which is hereby incorporated by reference herein). The main aspect of GEM is constraining the loss on the episodic memory to decrease while updating the network's parameters for the new task t. This is achieved by adding the decrease of the loss on the memory for all tasks as a constraint in the search for parameters after observing a new example:

$$\begin{matrix}arg {min}_{V} & \frac{1}{2} {v}^{T} R {R}^{T} v + {r}^{T} {R}^{T} v\end{matrix} \\ \begin{matrix}subject to & v \geq 0.\end{matrix} \qquad ( 2 )$$

Both methods, EWC and GEM, and the families they represent depend on an episodic memory on which the learning objective concentrates. Despite the dependence on samples stored from previous tasks, these methods suffer from forgetting previous tasks due to ignoring the modular relatedness of architecture sub-components to previous tasks.

### SUMMARY

In an embodiment, the present invention provides a method for modular-based techniques for continual learning applications. The method includes the steps of: training a neural network based on learning a plurality of parameters associated with the neural network using input data associated with a current task, wherein the neural network comprises a plurality of layers, and wherein a first layer, of the plurality of layers, comprises a plurality of nodes; and performing modularization of the neural network to group the plurality of nodes of the first layer into at least two separate groups.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 shows a process for using modularization-based techniques with continual learning applications according to an embodiment of the present invention;

FIG. 2 schematically shows a method and system architecture for using modularization-based techniques with continual learning applications according to an embodiment of the present invention is shown;

FIG. 3 shows a process of using modular-based techniques with continual learning applications for demand of transport prediction according to an embodiment of the present invention;

FIG. 4 shows a process of using modular-based techniques with continual learning applications for preventive maintenance according to an embodiment of the present invention;

FIG. 5 shows a flowchart for using modularization-based techniques with continual learning applications according to an embodiment of the present invention; and

FIGS. 6A and 6B show a graphical representation of the retained accuracy performance curves for ModEWC, ModGEM, and their original methods EWC and GEM.

### DETAILED DESCRIPTION

Embodiments of the present invention provide a method and system for modular adaption for continual learning that takes into account the relatedness of previous approaches (e.g., previous machine learning models). The system and method include big advantages in reducing catastrophic forgetting (e.g., catastrophic interference, which is a tendency of an artificial neural network to completely and abruptly forget previously learned information upon learning new information), especially when the memory budget is limited.

Among other advantages, embodiments of the present invention use continual learning (CL) techniques that are beneficial to sequential task learners by improving their retained accuracy and reducing catastrophic forgetting. In other words, the present invention includes automatic extraction of modular parts/components of the neural network and then estimating the relatedness between the tasks given these modular components. The present invention is applicable to different families of CL methods such as regularization-based (e.g., the Elastic Weight Consolidation) or the gradient-based (e.g., the Gradient Episodic Memory) approaches where episodic memory may be needed. As will be shown below, empirical results demonstrated remarkable performance gain (in terms of robustness to forgetting) for methods such as EWC and GEM based on using the present invention, especially when the memory budget is very limited.

In an embodiment, the present invention provides a method for modular-based techniques for continual learning applications. The method includes the steps of: training a neural network based on learning a plurality of parameters associated with the neural network using input data associated with a current task, wherein the neural network comprises a plurality of layers, and wherein a first layer, of the plurality of layers, comprises a plurality of nodes; and performing modularization of the neural network to group the plurality of nodes of the first layer into at least two separate groups.

In an embodiment, performing the modularization of the neural network is based on using an expectation-maximization algorithm.

In an embodiment, performing the modularization of the neural network is based on clustering using a covariance matrix.

In an embodiment, the method further comprises: performing relatedness computation based on computing a relatedness associated with the at least two separate groups of the plurality of nodes; and providing an update signal to update the neural network for a next batch of data associated with a new task.

In an embodiment, computing the relatedness comprises determining, for each group of the at least two separate groups, one or more discrepancies between conditional distributions of the current task and a plurality of previous tasks, and providing the update signal comprises generating the update signal based on employing the one or more determined discrepancies for training on a next batch of data associated with the new task.

In an embodiment, performing the relatedness computation is based on weighing parameters of one or more subsequent tasks inversely proportion to a distance associated with a similarity of the current task on the plurality of nodes.

In an embodiment, the current task comprises a current route used by a plurality of public transportation vehicles and the new task comprises a new route to be used by the plurality of public transportation vehicles, the input data comprises a plurality of demands of use for transport of the current route, and performing the modularization of the neural network comprises performing the modularization of the neural network such to promote transfer of the plurality of nodes from the current route to the new route.

In an embodiment, the current task is a prediction of a time for preventative maintenance of a vehicle, and the input data is collected from on-board equipment on the vehicle and comprises: a distance that the vehicle has driven, an amount of time that the vehicle has driven, status of internal sensors, and measurements of the internal sensors.

In an embodiment, computing the relatedness associated with the at least two separate groups of the plurality of nodes is based on one or more parameters of previously trained neural networks and subsamples of data from one or more previous tasks.

In an embodiment, the neural network is an Elastic Weight Consolidation (EWC) neural network, and performing modularization of the neural network comprises performing modularization of the EWC neural network.

In an embodiment, the neural network is a Gradient Episodic Memory (GEM) neural network, and performing modularization of the neural network comprises performing modularization of the GEM neural network.

In another embodiment, the present invention provides a system comprising one or more processors. The one or more processors are configured to provide for execution of a method comprising: training a neural network based on learning a plurality of parameters associated with the neural network using input data associated with a current task, wherein the neural network comprises a plurality of layers, and wherein a first layer, of the plurality of layers, comprises a plurality of nodes; and performing modularization of the neural network to group the plurality of nodes of the first layer into at least two separate groups.

In an embodiment, the one or more processors are configured to provide for execution of the method further comprising: performing relatedness computation based on computing a relatedness associated with the at least two separate groups of the plurality of nodes; and providing an update signal to update the neural network for a next batch of data associated with a new task.

In an embodiment, computing the relatedness comprises determining, for each group of the at least two separate groups, one or more discrepancies between conditional distributions of the current task and a plurality of previous tasks, and providing the update signal comprises generating the update signal based on employing the one or more determined discrepancies for training on a next batch of data associated with the new task.

In a further embodiment, a tangible, non-transitory computer-readable medium having instructions thereon which, upon being executed by one or more processors, alone or in combination, provide for execution of a method according to any embodiment of the present invention.

In order to overcome the loss in performance of traditional approaches, embodiments of the present invention provide one or more modularization-based techniques that may be employed by many continual learning methods. The extension and improvement of two of the state-of-the-art continual learning methods will be described below.

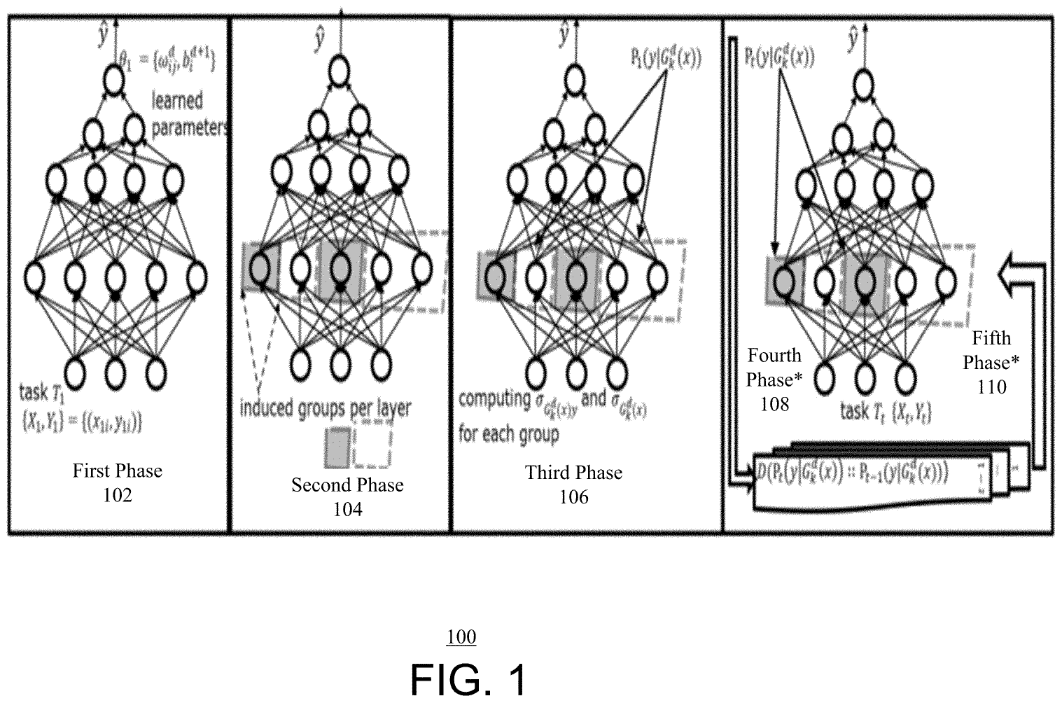

Referring to FIG. 1, a process 100 for using modularization-based techniques with continual learning applications according to an embodiment of the present invention is shown. For example, the method 100 may be a general approach that starts by learning the continual learning model's parameters on the first task T₁ and then finding the modular groups for each network's layer. The choice of modularization method, in method 100, may be seen as a utility to be employed without fixing the selection of it. The general approach of modular-relatedness for continual learning includes five phases 102-110, which are described below. In some instances, the phases 102-110 may be performed by a computing system with one or more computing devices. Each computing device may include one or more processors and memory. The memory may store instructions, that when executed by the one or more processors, may perform one or more of the phases 102-110.

In the first phase 102, a computing system trains the initial model parameters θ={wᵢⱼ^{d}, bᵢ^{d+1}|d∈{1, . . . , D−1}} for the first task, T₁. θ is the set of all parameters, wᵢⱼ^{d} are the weights of the connections between the units uᵢ^{d} in the dth layer and the units uⱼ^{d+1} in the (d+1)th layer, and bᵢ^{d} are the bias terms of the units in the dth layer. For instance, a neural network is shown in the first phase 102. The neural network includes a plurality of layers (e.g., rows) with each of the layers including a plurality of nodes (e.g., the circles shown in the first phase 102) that loosely model the neurons in a biological brain. Each of the nodes are connected to the nodes in the subsequent layer via connectors such as edges (e.g., shown as the arrows from the nodes in the first phase 102). The edges typically are associated with a weight that indicates the strength of the connection or the likelihood the node transitions to the new node. For example, as shown, the first layer (e.g., the bottom layer) of the neural network includes three nodes. Each of these nodes have five edges and each of these edges connects the node from the first layer to a different node from the second layer (e.g., the second from the bottom layer). Each of these five edges is associated with a weighted value indicating the strength of connection between the node from the first layer to a node from the second layer.

In the first phase 102, the computing system may receive training data associated with performing the first task, T₁, and use the training data train the model parameters (e.g., the weights associated with the edges). In other words, the computing device may compare the output from the neural network with the expected output. Then, using one or more loss functions (described above), the computing system may adjust/update/train the model parameters to improve the accuracy of the model until the accuracy reaches a certain threshold.

In the second phase 104 and after the initial model parameters have been trained for the first task, the computing system performs induction of the modular groups {g₁^{d}, . . . , g_{K-1}^{d}} for each layer d∈{2, . . . , D−1}. gᵢ^{d} is the modular group in layer d, and D is the number of layers. For example, as shown, the second layer within the neural network has been induced into two separate groups (e.g., a first group with two nodes that have been shaded and a second group with the three remaining nodes that have a dotted box around them). The computing system may induce these nodes into particular groups based on the modularization technique. The modularization technique may be applied using many different techniques/methods, including, but not limited to, a community detection method, a statistical independence-based method and/or random grouping.

In the third phase 106, the computing system computes covariance matrices σ_{G}_{ₖ}_{^{d}}_{(x)y} characterizing P₁(Gₖ^{d}(x),y) and P₁(Gₖ^{d}(x)), respectively, for each group Gᵢ^{d}, for each forthcoming task Tₜ. Gₖ^{d}(x) is the function representing the group gₖ^{d}, P₁ is the probability distribution.

The fourth phase 108 and the fifth phase 110 are performed iteratively. For instance, in the fourth phase 108, the computing system computes, for each group, gᵢ^{d}, the discrepancy between the conditional distributions of the current task Tₜ and the previous tasks Tₖ(k<t). In the fifth phase 110, the computing system employs the computed discrepancies for the training on the next batches of data.

The below describes applying process 100 (e.g., using modularization-based techniques) to two different continual learning methods (e.g., elastic weight consolidation (EWC) and gradient episodic memory (GEM)).

Modular EWC

Regarding Modular EWC, a modularization-based process that considers the divergence between the probabilities of the tasks (more precisely, between the representations of the tasks) given the modular slicing of the network is described below.

In this process, the change to parameters belonging to the same group is regularized together taking into account (i) their relatedness to the different tasks (through the divergence estimation), and (ii) the parameter's interdependence through the modularization step. Taking these two aspects into consideration, EWC's objective becomes:

$$\begin{matrix}ℒ ( θ ) = {ℒ}_{{T}_{B}} ( θ ) + {\sum }_{{T}_{A} ∈ 𝕋 ∖ \{ {T}_{B} \}} {\sum }_{k , d} {r}_{k , d}^{A} {\sum }_{{θ}_{i} ∈ {g}_{k}^{d}} {( {θ}_{i} - {θ}_{{T}_{A} , i}^{*} )}^{2} , & ( 2 ) \\ {r}_{k , d}^{A} = \frac{1}{Z} \frac{λ}{2} exp ( - D ( {p}_{{T}_{A}} ( y \vert x , {g}_{k}^{d} ) ∷ {p}_{{T}_{B}} ( y \vert x , {g}_{k}^{d} ) ) ) , & ( 3 )\end{matrix}$$

In other words, the first sum in Equation (2) iterates over the tasks T_{A}, the second sum is over the groups gᵢ^{d} of every layer d, and the third sum iterates over the parameters concerning units in the group gₖ^{d}. Equation (3) computes the relatedness (gₖ^{d})^{A} between the representations of T_{A} and T_{B} given the group gₖ^{d}; this relatedness takes the form of the Softmax of the negative divergence with Z being the normalization term. r_{k,d}^{A} is the computed relatedness, p_{T}_{_{A}} and p_{T}_{_{B}} are the densities of tasks T_{A} and T_{B}. The main role of this formula is to penalize the changes in the parameters' vector based on the relatedness of the tasks T_{A} and T_{B} given the group gₖ^{d}.

The motivation behind employing modularization here is that regularization comes over groups of parameters and, hence, taking their correlations into account, unlike EWC which takes only the diagonal of the Fisher information matrix that otherwise would be computationally expensive. Moreover, the relatedness is computed as the negative discrepancy defined as:

D_{φ,B}(p_{A}(y|x)::p_{B}(y|x))=½(D_{φ,B}(P_{A}(y|x)∥P_{B}(y|x))+D_{φ,B}(P_{B}(y|x)∥(P_{A}(y|x))). (4)

D_{φ,B}(P_{A}(y|x)∥P_{B}(y|x))=D_{φ,B}(σ_{xy}^{A}∥ρ_{xy}^{B})−D_{φ,B}(σₓ^{A}∥ρₓ^{B}),

where σ_{xy}, ρ_{xy}∈S₊^{p+1} denote positive semidefinite matrices characterising the joint probability distributions P_{A}(x, y) and P_{B}(x, y), similarly σₓ, ρₓ∈S₊^{p} characterize the marginal distributions P_{A}(x) and P_{B}(x). One realization of σ and ρ may be the covariance matrix, or the centered correntropy matrix, which may require that σ and ρ are of the same type. This relatedness can be efficiently computed without requiring to estimate the probability distribution in high-dimensional spaces. Equation (4) would then be the symmetric divergence between the conditional distributions is the p_{A}(y|x) and p_{B}(y|x).

Modular GEM

Regarding Modular GEM, the rethinking and improvement of GEM using a modularization-based process includes two main aspects: (i) the modular partitioning of the units of each of the network's layers, and (ii) the discrepancy estimation of each task's representation projected in each group.

The first aspect concerns the creation of the groups g₁^{d}, . . . , g_{K}_{_{d}}^{d} for each layer d∈{2, . . . , L−1}, and the second aspect leads to the computation of the discrepancy (rᵢ^{d})ₖ=D(Pₜ(y|Gᵢ^{d}(x; θ))::Pₖ(y|Gᵢ^{d}(x;θ))) between task t and each previous task k<t given the group gᵢ^{d}, which is described in Equation (4) above that describes the definition of the discrepancy.

The first part, grouping, allows the computing system to slice the gradients r of problem (1) (e.g., Eq. (1) described above in the background section) into r₁ the gradient for the first layer's parameters, and rᵢ^{d} the gradients for each group gᵢ^{d} in each layer d∈{2, . . . , L}, since each group gᵢ^{d} concerns the set of parameters θᵢ^{d}∈{wᵢⱼ^{d},bⱼ^{d+1}|uᵢ∈gᵢ^{d}∧ for each j}. Similarly, the gradient projection \tilde{r} that is searched for becomes [symbol] and [symbol] for each group gᵢ^{d}. This formulation allows the computing system to change the constraints such that the inner product is computed on the group-wise gradients and not all parameters at once. Therefore, the new problem is formulated as:

$$\begin{matrix}\begin{matrix}arg {min}_{\tilde{r}} & \frac{1}{2} ‖ r - \tilde{r} ‖ \frac{2}{2}\end{matrix} & ( 5 ) \\ \begin{matrix}subject to & 〈 , {( {r}_{i}^{d} )}_{k} 〉 \geq {( {h}_{i}^{d} )}_{k} for each {( {g}_{i}^{d} )}_{k} , k < t ,\end{matrix} & ( 6 ) \\ \begin{matrix}subject to & 〈 \tilde{{r}_{1}} , {( {r}_{1} )}_{k} 〉 \geq 0 for k < t ,\end{matrix} & ( 7 )\end{matrix}$$

where (hᵢ^{d})ₖ is proportional to the inverse of exp (−(rᵢ^{d})ₖ) and normalized over the seen tasks k<t. r is the gradient, r is the projected gradient, and gᵢ^{d} is the group. In other words, for a group that establishes a strong relation between the current and the previous task, the angle between its gradients [symbol] and (rᵢ^{d})ₖ may be smaller than that when such a relation is absent.

As such, the primal problem of the quadratic program solving (4-6) becomes:

$$arg {min}_{Z} \frac{1}{2} {z}^{T} z - {r}^{T} z + \frac{1}{2} {r}^{T} r \\ subject to Rz \geq H , \qquad ( 8 )$$

where H=((hᵢ^{d})₁, . . . , (hᵢ^{d})ₜ₋₁) and R=((r₁)¹, (rᵢ^{d})₁, . . . , (r₁)ₜ₋₁, (rᵢ^{d})ₜ₋₁). The dual problem becomes:

$$arg {min}_{V} \frac{1}{2} {v}^{T} R {R}^{T} v + {r}^{T} {R}^{T} v \\ subject to v \geq h . \qquad ( 9 )$$

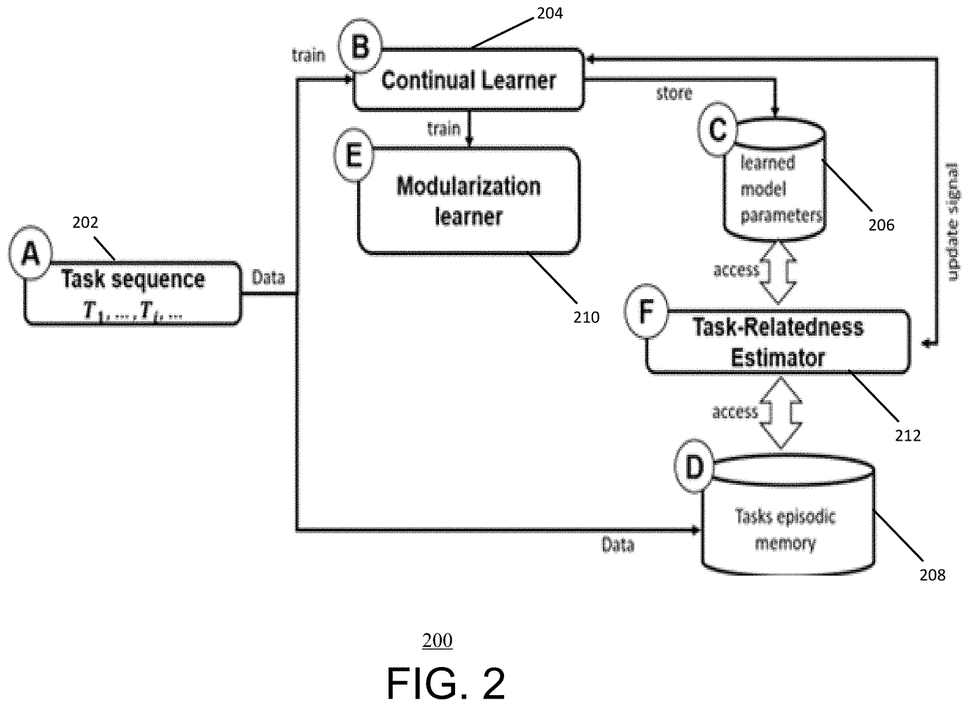

Referring to FIG. 2, a method and system architecture 200 for using modularization-based techniques (e.g., process 100) with continual learning applications according to an embodiment of the present invention is shown. To put it another way, the method and system architecture 200 shows a modular continual learning framework based on task-relatedness and describes the main components and dataflow between the components.

As shown, the method and system architecture 200 includes a task sequence 202, a continual learner 204, the learned model parameters 206, the tasks episodic memory 208, the modularization learner 210, and the task-relatedness estimator 212. The main components:

A) Sequence of Tasks 202 has input data consisting of samples; these samples belong to the sequence of tasks.

B) Continual Learner 204—This component is the learning algorithm of tasks that induces models from data.

C) Learned model parameters 206—This is a database of the parameters of the already trained models.

D) Task episodic memory 208—This database keeps subsamples of the data from the already seen tasks.

E) Modularization Learner 210—This component of the framework/architecture 200 learns the groupings of units in the different layers.

F) Task-Relatedness Estimator 212—This component computes how different modular parts of the network are related given the previous tasks.

The dataflow of the generic method is described as follows:

1) Data Collection: this is the acquisition stage after which received data is presented to: a) Continual Learner (B) 204 and b) Task episodic memory (D) 208.

2) Model and parameters learning. Here, the continual task learner (B) 204 fits the model's parameters and insets them into the database of learned models parameters (C) 206.

3) The modularization learner/component 210 computes the valid groupings of each layer's units.

4) The task-relatedness estimator 212 computes how the groups of each layer are related given the episodic memory 208. This component 212 sends an update signal to the continual learner 204. This update signal informs the continual learner 204 how the two tasks are related in terms of estimated relatedness, which may be integrated into the objective function.

The below describes an embodiment for demand prediction for transportation using modularization-based techniques (e.g., process 100 and/or method and system architecture 200) for continual learning applications.

Considering the demand of each vehicle in public transport as a task, the process 100 may be used in a continual learning framework (e.g., the method/system architecture 200) by learning to separate parts of the network depending on their relation to the different routes (e.g., tasks). The relatedness may be computed using a very small portion of the history that is stored in the episodic memory.

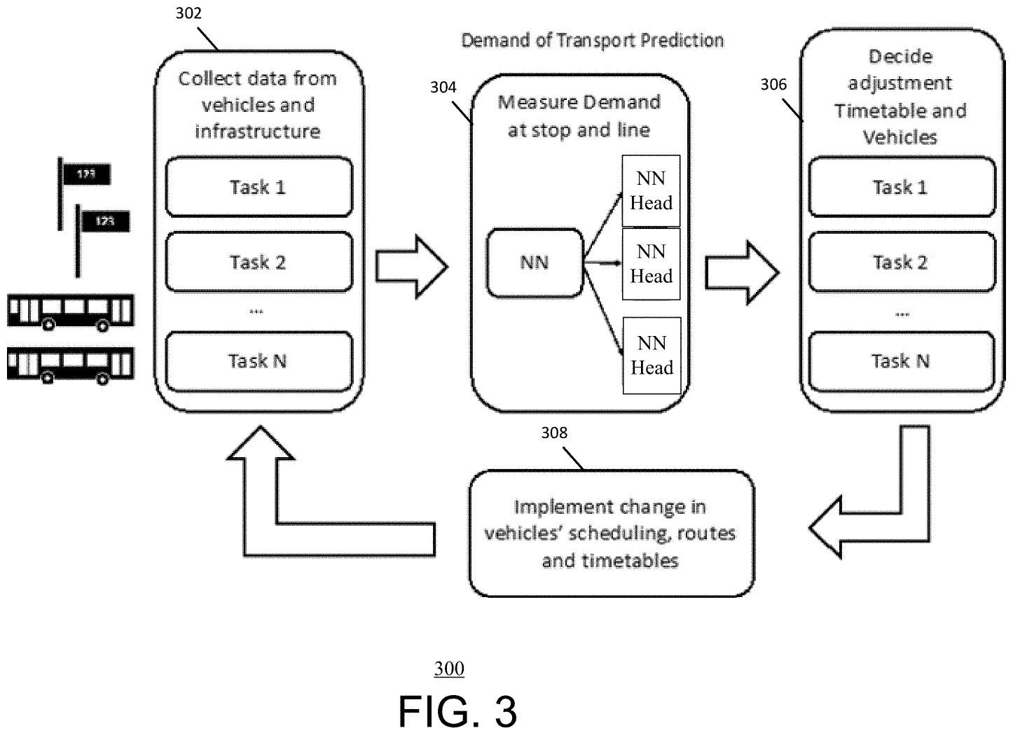

FIG. 3 shows a process 300 of using modular-based techniques with continual learning applications for demand of transport prediction according to an embodiment of the present invention. In other words, process 300 describes how the demand for transport of the single route is derived by the data from vehicles and stations. The data is fed continuously, and even if the routes have a similarity, the necessity is to adapt to the task but still generalize to an unknown situation. For instance, at block 302, the computing system collects data from vehicles and infrastructures for a plurality of tasks. At block 304, the computing system measures demand at stop and line by using a neural network (NN) and NN heads. At block 306, the computing system decides adjustment timetable and vehicles for the tasks. At block 308, the computing system implements change in vehicles' scheduling, routes, and timetables.

To put it another way, the process 300 modularizes the neural network such to promote the transfer of learned parameters from one task (route) to another (route), such that the network learning adapts to new tasks, routes, or vehicles. To this end, the learned network on the first route is divided into groups, thereafter the relatedness to each new route is computed given each of the modular components of the network.

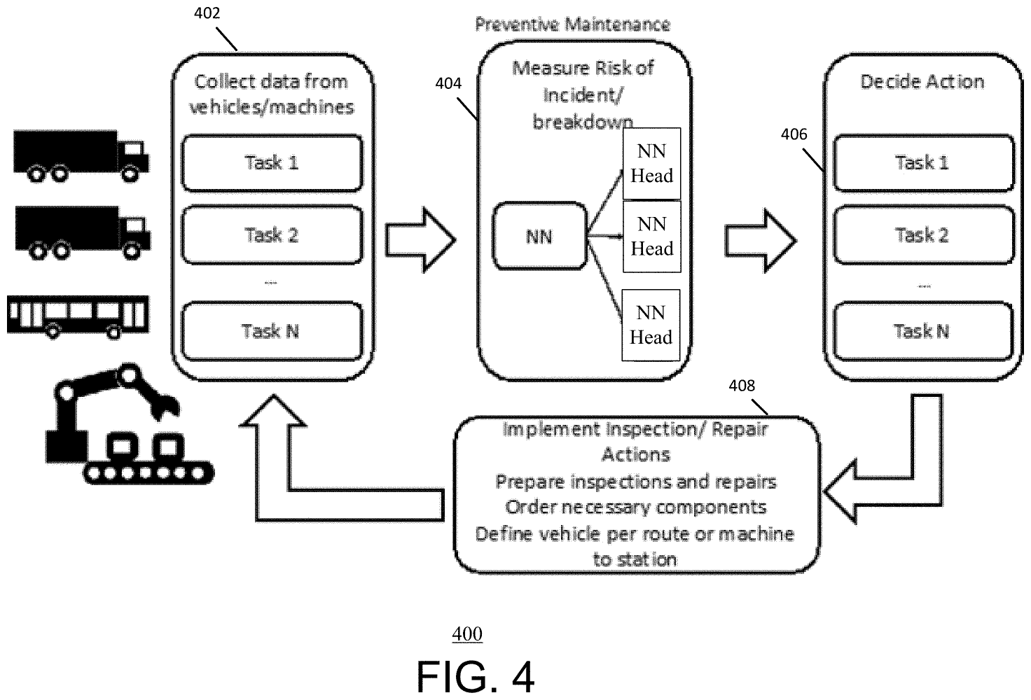

The prediction, as shown in FIG. 4, is used to implement changes on the system, as change in the routes or times. The task is to predict the demand of use at specific locations or at specific elements, as vehicles, using as input the past demand, the date and time and other external factors as traffic and weather.

By using the modular-based approach, the following is enabled:

1. Adapt to changing task definition but still retain performance on previously learned tasks

2. Limit the update on the modules of the network of similar tasks, thus improving the speed of training

The below describes an embodiment for preventative maintenance of one or more vehicles using modularization-based techniques (e.g., process 100 and/or method and system architecture 200) with continual learning applications. This will be described with reference to FIG. 4. FIG. 4 shows a process 400 of using modular-based techniques with continual learning applications for preventive maintenance according to an embodiment of the present invention. For instance, at block 402, the computing system collects data from vehicles/machines. At block 404, the computing system measures risk of incident/breakdown using a neural network (NN) and NN heads. At block 406, the computing system decides one or more actions. At block 408, the computing system implements inspection/repair actions, prepare inspections and repairs, order necessary components, and/or define vehicle per route or machine to station.

In other words, large fleet operators, but also industrial automation applications (e.g. factory production chain), may require continuously monitoring and maintaining operation during service with a high level of availability. Predictive maintenance is the task of deciding which machine performs a specific task given the probability that that machine is able to perform the task until the end. For example, a vehicle that needs to be repaired shortly is not assigned to a long trip, but short delivery or a machine that is used to produce a highly critical process is maintained before the task. Each task (machine operating on a specific operation or a vehicle operating on a specific route) is different and varies over time, while new data is collected every day. The prediction of breakdown is used to decide which machine operates on which operation. To improve service availability, it is critical to integrate different information and to update the models such that the performance improves overtime on old and new tasks. Using the modular-based techniques with continual learning applications may improve the accuracy of the prediction in this continual operation environment by modularizing the neural network and, thus, taking advantage of the similarity of the tasks on the single module to avoid forgetting and promote forward transfer learning.

In other words, consider the case where the machines to monitor are vehicles in a fleet of vehicle. In this case, the task is the model of the single vehicle, where the input data are collected from the on-board equipment, while the output data are the repair events (regular and not planned). Example of input data are: driven kilometers, driven hours, status of internal sensors, reading of sensors (as rain sensors, liquid levels, air pressure of tires, microphones recording) including human annotations or input from management systems (type of goods, customers location). In general, the task is to predict the time to the next intervention, the elements that need to be repaired and the time of repairing. The input are the data associated with the machinery, linked to the use: time, movement, external factors.

By using the proposed approach, the following is enabled:

1. Adapt to changing task definition but still retain performance on previously learned tasks.

2. Limit the update on the modules of the network of similar tasks, thus improving the speed of training.

3. Increase the availability of the service (reduce the downtime), but also avoid cost for repairing out of schedule.

According to an embodiment of the present invention, a method and system for using modularization-based techniques with continual learning applications comprises the steps of:

Step B: Model learning using the component B (e.g., the continual learner 204). In this step, the model's parameters are learned on the current task.

Step E: Modularization: Component E (e.g., the modularization learner 210) learns the groupings of units in the different layers. This learning may be achieved either using wither the Expectation-Maximization algorithm and/or clustering using the covariance matrix.

Step F: Relatedness computation through component F (e.g., task-relatedness estimator 212) by computing how different modular parts of the network (e.g., neural network) are related given the previous tasks.

Embodiments of the present invention provide for at least the following improvements and advantages:

1) The functions and processes being performed by the task-relatedness estimator 212 (e.g., Step F) of FIG. 2. In other words, the task-relatedness estimator 212 defines how the task-relatedness is applied to induce the relations between the different parts of the network (e.g., neural network/artificial intelligence algorithm) given the previous tasks; by weighting the parameters of subsequent tasks inversely proportional to the distance in term of task similarity on the group of parameters/neurons/nodes. For instance, component E (e.g., the modularization learner 210) performs the induction of the modular groups. For each new task, Components A (e.g., task sequence 202), F (e.g., task-relatedness estimator 212), and B (e.g., continual learner 204) perform their processes (as described above) iteratively. For each module, the component F (e.g., task-relatedness estimator 212) computes the discrepancy between the conditional distributions of the current task and the previous tasks. Component B (e.g., continual learner 204) employs the computed discrepancies for the training on the next batches of data.

2) An evaluation of using the present invention in contrast to the current state of the art is provided below that shows tangible advantages and improvements of using the invention as compared to the state of the art. The evaluation was performed on the Mixed National Institute of Standards and Technology (MNIST) Permutations (mnistP) dataset, which is a variation of MNIST, where each task contains a fixed permutation of the MNIST's input pixels. MNIST Rotations (mnistR) is another continual learning variant of MNIST where the MNIST images are rotated by a fixed angle between 0 and 180 degrees for each task.

Permuted Fashion-MNIST (fashionP) and Permuted notMNIST (notmnistP) datasets share the same format of MNIST but contain images of ZALANDO's clothing products and letters, respectively.

Comparing modular relatedness (e.g., modular EWC and/or modular GEM) versus EWC and GEM:

In the evaluation, a comparison is first performed for Modular EWC (ModEWC) versus EWC, under the online setting with the restricted memory budget of ten samples per task. Table 1 below shows how the present invention improves retained accuracy (RA) by 20% on the fashionP dataset, and around 6% and 4% for the notmnistP and mnistP, respectively. ModEWC also performs better than EWC on mnistR without a significant difference. In terms of learning accuracy, both methods perform comparatively similar on notmnistP and mnistR, whereas, ModEWC shows substantial improvement of the learning accuracy on fashionP and mnistP. This is a clear sign of a missing forward transfer that EWC fails to achieve under the circumstances of limited memory compared to ModEWC. The gain in both learning accuracy (LA) and RA that the modification of the present invention causes to EWC is accompanied by a better backward transfer (BTI) on all data sets.

TABLE 1

| Data | Method | RA | LA | BTI |
|---|---|---|---|---|
| notmnistP | EWC | 68.65 | 80.98 | −12.33 |
| | | (0.28) | (0.13) | (0.21) |
| | ModEWC | 72.31 | 79.46 | −07.15 |
| | | (0.3) | (0.1) | (0.21) |
| fashionP | EWC | 42.24 | 56.24 | −14.0 |
| | | (2.14) | (1.4) | (0.81) |
| | ModEWC | 62.47 | 66.64 | −4.17 |
| | | (0.31) | (0.12) | (0.28) |
| mnistR | EWC | 62.1 | 85.56 | −23.46 |
| | | (0.26) | (0.07) | (0.27) |
| | ModEWC | 62.85 | 83.62 | −20.77 |
| | | (0.19) | (0.07) | (0.18) |
| mnistP | EWC | 66.1 | 76.95 | −10.85 |
| | | (1.9) | (0.65) | (1.25) |
| | ModEWC | 71.82 | 80.78 | −8.96 |
| | | (0.24) | (0.07) | (0.24) |

Table 1 shows the comparison of performance results between Mode-EWC and EWC in terms of LA, RA, and BTI on notmnistP, mnistR, mnistP, and fashion over ten tasks with a memory budget of ten samples per task. The results are averaged over ten iterations with different seeds. Each number between the parentheses is the standard error of the mean computed in the previous row.

In the second evaluation, a comparison is performed for Modular GEM (ModGEM) versus GEM using the same setting used in the previous experiment, online and a memory budget of ten samples per task.

Table 2 below shows that ModGEM outperforms GEM on each of notmnistP, mnistP and fashionP with margins of 4%, 4%, and 2% retained accuracy, respectively. The only exception here is mnistR, where GEM is only 1.6% better than ModGEM. Both methods have relatively the same learning accuracy, which results in a better backward performance achieved by ModGEM.

TABLE 2

| Data | Method | RA | LA | BTI |
|---|---|---|---|---|
| notmnistP | GEM | 64.2 | 78.6 | −14.36 |
| | | (0.4) | (0.1) | (0.4) |
| | ModGEM | 68.41 | 80.51 | −12.1 |
| | | (0.2) | (0.1) | (0.2) |
| fashionP | GEM | 56.86 | 67.4 | −10.54 |
| | | (0.18) | (0.1) | (0.17) |
| | ModGEM | 58.47 | 67.52 | −9.05 |
| | | (0.14) | (0.06) | (0.15) |
| mnistR | GEM | 75.75 | 85.05 | −9.3 |
| | | (0.2) | (0.07) | (0.21) |
| | ModGEM | 74.15 | 85.19 | −11.04 |
| | | (0.22) | (0.06) | (0.19) |
| mnistP | GEM | 64.4 | 80.38 | −15.97 |
| | | (0.25) | (0.07) | (0.26) |
| | ModGEM | 68.57 | 80.37 | −11.8 |
| | | (0.14) | (0.11) | (0.12) |

Table 2 shows a comparison of performance results between ModGEM and GEM in terms of LA, RA, and BTI on notmnistP, mnistR, mnistP, and fashion over ten tasks with a memory budget of ten samples per task. The results are averaged over ten iterations with different seeds. Each number between parentheses is the standard error of the mean computed in the previous row.

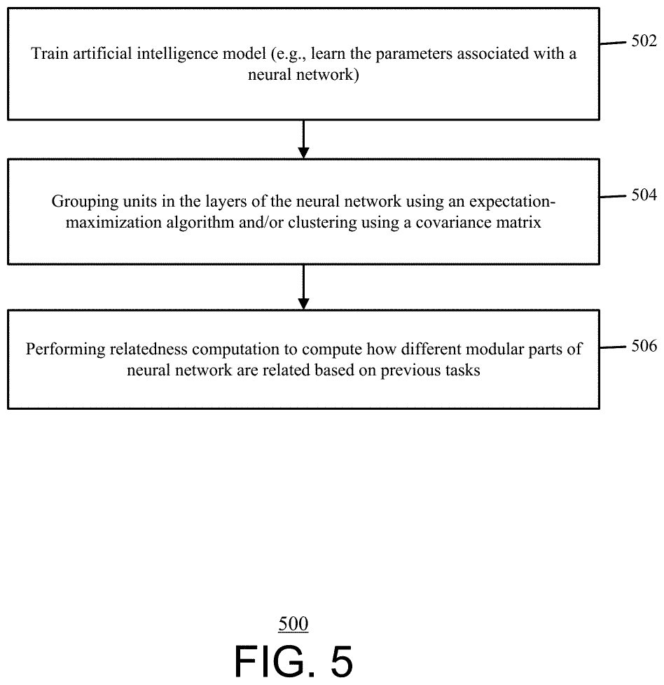

FIG. 5 is an exemplary flowchart 500 for using modularization-based techniques with continual learning applications in accordance with one or more embodiments of the present application. The descriptions, illustrations, and processes of FIG. 5 are merely exemplary and the flowchart 500 may use other descriptions, illustrations, and processes. The flowchart 500 may be performed by a computing system comprising one or more computing devices. The computing devices may include one or more processors and memory. The memory may store instructions that when executed by the one or more processors, are configured to perform one or more blocks of flowchart 500.

In operation, at block 502, a computing system uses a continual learner (e.g., the continual learner 204) to train/learn an artificial intelligence/machine learning model (e.g., a continual learning model and/or a neural network) for a current task. For example, the computing system may receive input data associated with a current task. The computing system may use the input data to learn (e.g., train) the model's parameters for the current task (e.g., the parameters associated with the neural network).

At block 504, the computing system uses a modularization learner (e.g., modularization learner 210) to determine (e.g., learn) the grouping of the units in the different layers. This may be performed by using an expectation-maximization algorithm and/or clustering using a covariance matrix.

At block 506, the computing system uses a task-relatedness estimator to perform relatedness computation to compute how different modular parts of the neural network are related based on the previous tasks.

In the following, particular embodiments of the present invention are described, along with experimental results illustrating computational improvements achieved. To some extent, the following description uses different terminology or symbols to refer to the same components or notations which are used in embodiments of the present invention described above, but would be understood by ordinarily skilled artisans as referring to the same or similar components or notations.

A continual learning (CL) technique is described herein that is beneficial to sequential task learners by improving their retained accuracy and reducing catastrophic forgetting. The principal target of the present invention is the automatic extraction of modular parts of the neural network and then estimating the relatedness between the tasks given these modular components. This technique is applicable to different families of CL methods such as regularization-based (e.g., the Elastic Weight Consolidation) or the gradient-based (e.g., the Gradient Episodic Memory) approaches where episodic memory is needed. Empirical results demonstrate remarkable performance gain (in terms of robustness to forgetting) for methods such as EWC and GEM based on the present invention's technique, especially when the memory budget is very limited.

A novel CL framework based on modularization is described herein, which enables automatically discovering groups of neurons (in each layer) that are mutually independent or less dependent, and to reuse those grouping to identify network parameters that are most relevant to previous tasks.

Two methodologies to implement the modularization are disclosed herein, including a likelihood-based one and independence-based one.

Generalize the understanding of modularization in neural network in a higher perspective by random grouping is described, in which similar performances are observed to the two mentioned methodologies with less computational cost.

Problem Definition

Sequential task learning: Consider T classification tasks [symbol] ={(Xₜ, Yₜ)|t∈{1 . . . , T}}, where each task t is represented by the set of Nₜ data samples {Xₜ, Yₜ}={(xₜᵢ, yₜᵢ):i∈{1, . . . , Nₜ}}, xₜᵢ∈ [symbol] ^{p}^{ₜ} an input instance for the task t with pₜ dimensionality, while yₜᵢ∈ [symbol] ₜ={c₁, . . . , cₘ_{ₜ}} is a class label taken from the mₜ unique categories. This formulation is the generic one that multi-task and continual approaches often consider. For simplicity, the setting is targeted when pₜ=p, mₜ=m, and [symbol] ₜ= [symbol] for all t∈{1, . . . , T}.

Neural network parametrization: Consider representing the neural network by the function ƒ(x; θ): [symbol] ^{p}^{ₜ}␣[0,1]^{|} [symbol] ^{|} that computes the score ƒ_{c}(x;θ) for each category c∈ [symbol] being the correct label for the instance x through a multilayered neural network parameterized by θ∈Θ. For a D-layered network, the set of parameters θ={wᵢⱼ^{d}, bᵢ^{d+1}|d∈1, . . . , D−1} contains the weights ωᵢⱼ^{d} of the connections between the units uᵢ^{d} in the dth layer and the units uⱼ^{d+1} in the (d+1) layer, and the bias terms bᵢ^{d} of the units in the dth layer. The scoring function resulted from the forward propagation in the D-layered network takes the form:

$$\begin{matrix}{f}_{j} ( x ; θ ) = ϕ ( {\sum }_{i} {ω}_{ij}^{D - 1} {o}_{i}^{D - 1} + {b}_{j}^{D} ) & ( 10 ) \\ {o}_{j}^{d} = ϕ ( {\sum }_{i} {ω}_{ij}^{d - 1} {o}_{i}^{d - 1} + {b}_{j}^{d} ) , & ( 11 )\end{matrix}$$

where oⱼ^{d} is the jth unit's output at the dth layer, oⱼ¹ represents the features of the input data, and ϕ is an activation function. In this regard, Eq. 11 is indeed the function oⱼ^{d}(x) that computes the representation of x given all the units of the previous layers 1, . . . , d−1 and the connections from layer d−1 to the unit uⱼ^{d}. For a given (regularized) loss function [symbol] , multi-task learning methods aim at finding a general parametrization θ that minimizes the objective [symbol] Σᵢ^{N}^{ₜ} [symbol] (ƒ(xₜᵢ;θ),yₜᵢ)), i.e., observing all tasks at the same time and minimizing their joint loss simultaneously.

Generally speaking, after learning on t−1 tasks, continual learning aims at finding θₜ that is the least harmful for the previous tasks:

arg min_{θ}_{ₜ} [symbol] (ƒ(Xₜ;θ),Yₜ) (12a)

S.t. [symbol] (ƒ(Xₖ;θₜ),Yₖ)≤ [symbol] (ƒ(Xₖ;Yₖ):k<t (12b)

even without having the ability to access {Xₖ, Yₖ} for k<t. Failing to satisfy the conditions in (Eq. 12a and/or 12b) means a deterioration on performance on previous tasks which is often referred to as catastrophic forgetting.

Modular Networks

Motivated by evidences from neuropsychology and neurobiology that animal and human brains are organized into segregated modules based on their functionality, a modular neural networks is an aggregation of computational independent sub-networks. Studies have proposed a modular decomposition of trained neural networks into a set of independent sub-networks. This decomposition considers the assignment of each unit uᵢ^{d} (in layer d) to a group gₖ as a latent variable which can be found by maximizing the likelihood of observing these groups given the connections to the previous and following layers, d−1 and d+1 respectively. To this end, expectation-maximization is employed to find the groups and their parameters. As a result, the groupings g₁^{d}, . . . , g_{K}_{_{d}}^{d}, of the dth layer's units, where K_{d} is the number of groups. From each group gᵢ^{d}, the function Gᵢ^{d} can be defined as:

Gᵢ^{d}(x;θ): [symbol] ^{p}^{ₜ}→ [symbol] ^{|g}^{ᵢ}^{^{d|}},Gᵢ^{d}(x;θ)=[oⱼ^{d}(x)|uⱼ^{d}∈gᵢ^{d}]. (13)

Exemplary Approach

Given the kth grouping in the dth layer, gₖ^{d}, the tasks T_{A} and T_{B}, and their underlying probability distributions, P_{A} and P_{B}, the estimate of their divergence conditioned on gₖ^{d} is given by D(P_{A}(y|x,gₖ^{d})∥P_{B}(y|x,gₖ^{d}))=D (P_{A}(y|Gₖ^{d}(x)|P_{B}(y|Gₖ^{d}(x))). Similarly, one could estimate the divergence based on the posterior distribution of the output labels i.e., D (P_{A}(ŷ|x,gₖ^{d})∥P_{B}(ŷ|x,gₖ^{d}))=D(P_{A}(ƒ(x;θ)|Gₖ^{d}(x)∥P_{B}(ƒ(x;θ)|Gₖ^{d}(x))).

A conditional discrepancy have been derived based on the Bregman matrix divergence D_{φ,B}(σ∥ρ)=φ(σ)−φ(ρ)−tr((∇φ(ρ))^{T}(σ−ρ)) between the two positive semidefinite matrices σ, ρΣ [symbol] ^{n×n} where φ: [symbol] ^{n×n}→ [symbol] is a strictly convex and differentiable function. The Bregman divergence represents a class of divergence functions where the von Neumann D_{vN} and the Log Det D_{lD} divergences can be instantiated based on the choice of φ. When φ(σ)=tr(σ log σ−σ), von Neumann divergence can be instantiated: D_{vN}(σ∥ρ)=tr(σ log σ−σ log ρ−σ+ρ), with log α being the matrix logarithm. When φ(σ)=log det σ, the LogDet divergence is instantiated:

$${D}_{ℓ D} ( σ ‖ ρ ) = {\sum }_{i , j} \frac{λ i}{θ j} {( {v}_{i}^{T} {u}_{j} )}^{2} - {\sum }_{i} log ( \frac{{λ}_{i}}{{θ}_{i}} ) - n .$$

This asymmetric conditional discrepancy between the two conditional probability distributions P_{A}(y|x) and P_{B}(y|x) is defined as the quantity:

D_{φ,B}(P_{A}(y|x)∥P_{B}(y|x))=D_{φ,B}(σ_{xy}^{A}∥ρ_{xy}^{B})−D_{φ,B}(σₓ^{A}∥ρₓ^{B}), (14)

where φ_{xy}, ρ_{xy}∈ [symbol] ₊^{p+1} denote positive semidefinite matrices characterizing the joint probability distributions P_{A}(x, y) and P_{B}(x, y), similarly σₓ, ρₓ∈ [symbol] ₊^{p} characterise the marginal distributions P_{A} (x) and P_{B} (x). One realization of σ and ρ could be the covariance matrix, or the centered correntropy matrix.

The symmetric conditional discrepancy between two distributions can be simply formulated as:

D_{φ,B}(p_{A}(y|x)::p_{B}(y|x))=½(D_{φ,B}(P_{A}(y|x)∥P_{B}(y|x))+D_{φ,B}(P_{B}(y|x)∥(P_{A}(y|x))). (15)

For simplicity, below, the subscripts of the D_{φ,B} are hidden.

Regularization-Based continual Learning Elastic Weight Consolidation

It has been argued, in Elastic Weight Consolidation (EWC), from a Bayesian point of view that the log-posterior probability of the parametrization θ, after seeing two consequent tasks T_{A} and T_{B}, can be decomposed into the log-likelihood of the task T_{B} given the current network and the log-prior log p(θ|T_{A}) (which is the same as the log-posterior given the previous task T_{A}), i.e., log p(θ|T_{A},T_{B})=log p(T_{B}|θ)+log p(θ|T_{A})−log p(T_{B}|T_{A}).

Using Laplace approximation, the log-posterior distribution log p(θ|T_{A}) is approximated by a Gaussian distribution with mean θ*_{A,i} and the inverse of the Hessian of the negative log-likelihood log p(θ|T_{A}) gives the variance. The is further simplified by taking the precision matrix as the diagonal Fisher information matrix F_{θ}. As a result, the loss function is re-written as:

$$ℒ ( θ ) = {ℒ}_{B} ( θ ) + {\sum }_{i} \frac{λ}{2} {{ℱ}_{{θ}_{i}} ( {θ}_{i} - {θ}_{A , i}^{*} )}^{2} , \qquad ( 16 )$$

with [symbol] _{B} (θ) being the loss for task B, λ is the importance of the previous task.

It has been shown that the KL-divergence D_{KL}(ρ_{θ}(y|x)∥p_{θ+Δθ}(y|x)) between conditional likelihoods of two neural networks parametrized by θ and θ+Δθ can be approximated as D_{KL}(p_{θ}(y|x)∥p_{θ+Δθ}(y|x))≈½Δ_{θ}^{T} [symbol] _{θ}Δ_{θ} where F_{θ} is the Fisher information matrix at θ, assuming that Δ_{θ}→0. Since it is infeasible to compute [symbol] _{θ} when the number of parameters is in the order of millions, parameters are assumed to be independent and only the diagonal of F_{θ} is computed, as a result, the divergence becomes D_{KL}(y|x)∥p_{θ+Δθ}(y|x))≈½ [symbol] _{θ}_{ᵢ}Δ_{θ} which collides with the regularization term of EWC (second term in Eq. 16). In the following, the present invention's Modular EWC (ModEWC), thereafter, shows a similar analysis that connects ModEWC with EWC from an information-theoretic point of view.

Modular EWC

The present invention discusses a modularization-based objective that considers the divergence between the probabilities of the tasks (more precisely, between the representations of the tasks) given the modular slicing of the network. In this objective, the change to parameters belonging to the same group is regularized together taking into account (i) their relatedness to the different tasks (through the divergence estimation), and (ii) the parameter's interdependence through the modularization step.

Referring to FIG. 1, the general approach of modular-relatedness for continual learning is shown. First Phase 102: training the initial model parameters θ={wᵢⱼ^{d}, bᵢ^{d+1}|d∈1, . . . , D−1} on the first task, T₁. Second Phase 104: the induction of the modular groups {g₁^{d}, . . . , g_{K}_{_{d}}^{d}} for each layer d. Third Phase 106: computing the covariance matrices σ_{xy} and σₓ characterizing P₁(x, y, gᵢ^{d}) and P₁(x, gᵢ^{d}) for each group gᵢ^{d}. For each forthcoming task t, the Fourth and Fifth Phases 108 and 110 are performed iteratively. Fourth Phase 108: for each group gᵢ^{d}, computing the discrepancy between the conditional distributions of the current task t and the previous tasks k<t. Fifth Phase 110: employing the computed discrepancies for the training on the next batches of data.

Taking these two aspects into consideration, EWC's objective becomes:

$$\begin{matrix}ℒ ( θ ) = {ℒ}_{{T}_{B}} ( θ ) + {\sum }_{{T}_{A} ∈ 𝕋 ∖ \{ {T}_{B} \}} {\sum }_{k , d} {r}_{k , d}^{A} {\sum }_{{θ}_{i} ∈ {g}_{k}^{d}} {( {θ}_{i} - {θ}_{{T}_{A} , i}^{*} )}^{2} , & ( 17 ) \\ {r}_{k , d}^{A} = \frac{1}{Z} \frac{λ}{2} exp ( - D ( {p}_{{T}_{A}} ( y \vert x , {g}_{k}^{d} ) ∷ {p}_{{T}_{B}} ( y \vert x , {g}_{k}^{d} ) ) ) , & ( 18 )\end{matrix}$$

where the first sum in Eq. (17) iterates over the tasks T_{A}∈ [symbol] \{T_{B}}, the second sum is over the groups gₖ^{d} of every layer d, and the third sum iterates over the parameters concerning units in the group gₖ^{d}. Equation (18) computes the relatedness r_{k,d}^{A} between the representations of T_{A} and T_{B} given the group gₖ^{d}; this relatedness takes the form of the softmax of the negative divergence with Z being the normalization term.

The motivation behind employing modularization here is that regularization becomes over groups of parameters and, hence, taking their correlations into account, unlike EWC which takes only the diagonal of the Fisher information matrix that otherwise would be computationally expensive. Moreover, the relatedness (the negative discrepancy defined in (15)) can be efficiently computed without requiring to estimate the probability distribution in high-dimensional spaces.

Special Relation to EWC

Consider the two conditional distributions p_{θ}_{₀}, p_{θ}_{ᵢ}, their exponential twist density pₜ(y|x) is defined as:

$$\begin{matrix}{p}_{t} ( y \vert x ) = \frac{{{p}_{{θ}_{0}} ( y \vert x )}^{1 - t} {{p}_{{θ}_{1}} ( y \vert x )}^{t}}{{Z}_{t}} & ( 19 ) \\ {Z}_{t} = {\int }_{y} {{p}_{{θ}_{0}} ( y \vert x )}^{1 - t} {{p}_{{θ}_{1}} ( y \vert x )}^{t} d y , 0 \leq t \leq 1 , & ( 20 )\end{matrix}$$

where Zₜ is the normalization function of t. The parameter t moves the probability density function pₜ along the manifold of densities between p_{θ}_{₀}, p_{θ}_{₂}. Following, the connection between the symmetric discrepancy measure (15) and the Fisher information matrix Fₚ_{ₜ} of pₜ(y|x) is established as follows,

$$\begin{matrix}{F}_{{p}_{t}} = {\int }_{y} {( \frac{d ln {p}_{t} ( y \vert x )}{d t} )}^{2} {p}_{t} ( y \vert x ) dy & ( 21 ) \\ = {\int }_{y} {( ln \frac{{p}_{{θ}_{1}} ( y \vert x )}{{p}_{{θ}_{0}} ( y \vert x )} )}^{2} {p}_{t} ( y \vert x ) d y - {( {\int }_{y} ln \frac{{p}_{{θ}_{1}} ( y \vert x )}{{p}_{{θ}_{0}} ( y \vert x )} {p}_{t} ( y \vert x ) d y )}^{2} , \\ & ( 22 ) \\ since \frac{d ln {p}_{t} ( y \vert x )}{d t} = ln \frac{{p}_{{θ}_{1}} ( y \vert x )}{{p}_{{θ}_{0}} ( y \vert x )} - ( {\int }_{y} ln \frac{{p}_{{θ}_{1}} ( y \vert x )}{{p}_{{θ}_{0}} ( y \vert x )} {p}_{t} ( y \vert x ) dy ) . & ( 23 )\end{matrix}$$

Kullback-Leiblar divergence D_{KL} and its first derivative, between pₜ(y|x) and p_{θ}_{₀}(y|x), can be written as

$$\begin{matrix}{D}_{K L} ( {p}_{t} ( y \vert x ) ‖ {p}_{{θ}_{0}} ( y \vert x ) ) = {\int }_{y} ln \frac{{p}_{t} ( y \vert x )}{{p}_{{θ}_{0}} ( y \vert x )} {p}_{t} ( y \vert x ) dy & ( 24 ) \\ = {\int }_{y} t ln \frac{{p}_{{θ}_{1}} ( y \vert x )}{{p}_{{θ}_{0}} ( y \vert x )} {p}_{t} ( y \vert x ) d y - ln {Z}_{t} \\ \frac{d {D}_{K L} ( {p}_{t} ( y \vert x ) ‖ {p}_{{θ}_{0}} ( y \vert x ) )}{d t} = {\int }_{y} t ln \frac{{p}_{{θ}_{1}} ( y \vert x )}{{p}_{{θ}_{0}} ( y \vert x )} \frac{d {p}_{t} ( y \vert x )}{d t} d y + {\int }_{y} ln \frac{{p}_{{θ}_{1}} ( y \vert x )}{{p}_{{θ}_{0}} ( y \vert x )} {p}_{t} ( y \vert x ) dy - \frac{d ln {Z}_{t}}{d t} & ( 25 ) \\ = t {\int }_{y} {p}_{t} ( y \vert x ) ln \frac{{p}_{{θ}_{1}} ( y \vert x )}{{p}_{{θ}_{0}} ( y \vert x )} ( ln \frac{{p}_{{θ}_{1}} ( y \vert x )}{{p}_{{θ}_{0}} ( y \vert x )} - \frac{d ln {Z}_{t}}{d t} ) dy & ( 26 )\end{matrix}$$

Comparing (22) and (26), it is noticed that

$$\frac{d {D}_{K L} ( {p}_{t} ( y \vert x ) ‖ {p}_{{θ}_{0}} ( y \vert x ) )}{d t} = t {F}_{{p}_{t}} , \qquad ( 27 )$$

knowing that

$$\frac{d ln {Z}_{t}}{dt} = {\int }_{y} ln \frac{{p}_{{θ}_{1}} ( y \vert x )}{{p}_{{θ}_{0}} ( y \vert x )} {p}_{t} ( y \vert x ) d y .$$

Similarly, one can easily see that

$$\frac{d {D}_{K L} ( {p}_{{θ}_{1}} ( y \vert x ) ‖ {p}_{t} ( y \vert x ) )}{dt} = ( 1 - t ) {F}_{{p}_{t}} .$$

Therefore, integrating over these two results yields

$$\begin{matrix}{\int }_{0}^{1} ℱ {p}_{t} d t = {\int }_{0}^{1} t ℱ {p}_{t} d t + {\int }_{0}^{1} ( 1 - t ) ℱ {p}_{t} dt & ( 28 ) \\ = {D}_{K L} ( {p}_{{θ}_{1}} ( y \vert x ) ‖ {p}_{{θ}_{0}} ( y \vert x ) ) + {D}_{K L} ( {p}_{{θ}_{0}} ( y \vert x ) ‖ {p}_{{θ}_{1}} ( y \vert x ) ) , & ( 29 )\end{matrix}$$

which is known as the Jensen-Shannon divergence. Notice the equivalence (proportional by a factor of ½) between the (29) and the symmetric conditional discrepancy (15), when the function [symbol] is the negative entropy. As a result, employing the measure (15) in a regularization-based method such as EWC (16) is equivalent to integrating over the full Fisher information matrix of every distribution along the geodesic between p_{θ}_{₀}(y|x) and p_{θ}_{₁}(y|x), instead of taking only the diagonal of the Fisher matrix and assuming that Δ_{θ}=θ₁−θ₀→0 as EWC does.

Gradient-Based Continual Learning

Gradient Episodic Memory

Gradient Episodic Memory (GEM) is a gradient-based continual learning method that has an episodic memory M storing a subset of the observed examples. For a total number of T tasks, for each task k, the set of examples Mₖ is preserved where |Mₖ|=|M|/T. The main aspect of GEM is constraining the loss on the episodic memory to decrease while updating the network's parameters for the new task t. This is achieved by adding the decrease of the loss,

$$l ( f ( ; θ ) , {M}_{k} ) = \frac{1}{{M}_{k}} {\sum }_{( {x}_{i} , {y}_{i} ) ∈ {M}_{k}} l ( f ( {x}_{i} ; θ ) , {y}_{i} ) ,$$

on the memory for all tasks as a constraint in the search for parameters after observing the example (x, y) from the current task t:

$$\begin{matrix}\begin{matrix}arg {min}_{θ} & l ( f ( x ; θ ) , y )\end{matrix} & ( 30 a ) \\ \begin{matrix}s . t . & l ( f ( ; θ ) , {M}_{k} ) \leq l ( {f ( ; θ )}^{t - 1} , {M}_{k} ) : k < t\end{matrix} & ( 30 b )\end{matrix}$$

where ƒ(;θ)^{t-1} is the found parametrization after learning the previous tasks t−1. Solving problem (30a and 30b) can be done efficiently by inferring an increase in the loss from the angle between the gradients of the loss before and after the update, which is referred to as rₖ and r, respectively. If all these constraints (a constraint for each previous task k) are satisfied, then the losses on the episodic memories should not increase. However, when one of these constraints is violated, the gradient r may be projected to the closest gradient \tilde{r} in squared l₂ norm, i.e, solving the following problem:

$$\begin{matrix}\begin{matrix}arg {min}_{\tilde{r}} & \frac{1}{2} ‖ r - \tilde{r} ‖ \frac{2}{2}\end{matrix} & ( 31 a ) \\ \begin{matrix}subject to & 〈 \tilde{r} , {r}_{k} 〉 \geq 0 for k < t .\end{matrix} & ( 31 b )\end{matrix}$$

Problem (31a and 31b) has the primal quadratic program:

$$\begin{matrix}\begin{matrix}arg {min}_{Z} & \frac{1}{2} {z}^{T} z - {r}^{T} z + \frac{1}{2} {r}^{T} r\end{matrix} & ( 32 a ) \\ \begin{matrix}subject to & Rz \geq 0 ,\end{matrix} & ( 32 b )\end{matrix}$$

where R is the matrix of the negative gradients on all previous t−1 tasks computed on the episodic memories Mₖ, R=(r₁; . . . ; rₜ₋₁). Instead of solving the primal problem (32a and 32b) whose number of variables could be in millions (the number of the network's parameters |\tilde{r}|=|θ|=|Θ|), the following dual problem is defined

$$\begin{matrix}\begin{matrix}arg {min}_{V} & \frac{1}{2} {v}^{T} R {R}^{T} v + {r}^{T} {R}^{T} v\end{matrix} & ( 33 a ) \\ \begin{matrix}subject to & v \geq 0.\end{matrix} & ( 33 b )\end{matrix}$$

Upon finding v, the projected gradient is computed as \tilde{r}=R^{T}v+r.

Modular GEM

The rethinking of GEM (e.g., Modular GEM) consists of two main aspects: (i) the modular partitioning of the units of each of the network's layers, and (ii) the discrepancy estimation of each task's representation projected in each group. The first aspect concerns the creation of the groups g₁^{d}, . . . , g_{K}_{_{d}}^{d} for each layer d E {2, . . . , L−1}, and the second aspect leads to the computation of the discrepancy (rᵢ^{d})ₖ=D (Pₜ(y|Gᵢ^{d}(x;θ))::Pₖ(y|Gᵢ^{d}(x;θ))) between task t and each previous task k<t given the group gᵢ^{d}, see the definition of the discrepancy in Eq. (15).

The first part, grouping, allows for slicing the gradients r of problem (31a and 31b) into r₁ the gradient for the first layer's parameters, and rᵢ^{d} the gradients for each group gᵢ^{d} in each layer d E {2, . . . , L}, since each group gᵢ^{d} concerns the set of parameters θᵢ^{d}={wᵢⱼ^{d}, bⱼ^{d+1}|uᵢ∈gᵢ^{d}∧ for each j}. Similarly, the gradient projection \tilde{r} that is searched for becomes \tilde{r}₁ and \tilde{r}ᵢ^{d} for each group gᵢ^{d}. This formulation allows for changing of the constraints such that the inner product is computed on the group-wise gradients and not all parameters at once. Therefore, the new problem is formulated as:

$$\begin{matrix}\begin{matrix}arg {min}_{\tilde{r}} & \frac{1}{2} ‖ r - \tilde{r} ‖ \frac{2}{2}\end{matrix} & ( 34 a ) \\ \begin{matrix}subject to & 〈 , {( {r}_{i}^{d} )}_{k} 〉 \geq {( {h}_{i}^{d} )}_{k} for each {( {g}_{i}^{d} )}_{k} , k < t ,\end{matrix} & ( 34 b ) \\ \begin{matrix}subject to & 〈 \tilde{{r}_{1}} , {( {r}_{1} )}_{k} 〉 \geq 0 for k < t ,\end{matrix} & ( 34 c )\end{matrix}$$

where (hᵢ^{d})ₖ is proportional to the inverse of exp(−(rᵢ^{d})ₖ) and normalized over the seen tasks k<t. In other words, for a group that establishes a strong relation between the current and the previous task, the angle between its gradients [symbol] and (rᵢ^{d})ₖ should be smaller than that when such a relation is absent. The primal problem of the quadratic program solving (34a-34c) becomes:

$$\begin{matrix}arg {min}_{Z} \frac{1}{2} {z}^{T} z - {r}^{T} z + \frac{1}{2} {r}^{T} r & ( 35 a ) \\ subject to Rz \geq H , & ( 35 b )\end{matrix}$$

where H=((hᵢ^{d}₁, . . . , (hᵢ^{d})ₜ₋₁) and R=((r₁)₁, (rᵢ^{d})₁, . . . , (r₁)ₜ₋₁(rᵢ^{d})ₜ₋₁). The dual problem becomes

$$\begin{matrix}arg {min}_{V} \frac{1}{2} {v}^{T} R {R}^{T} v + {r}^{T} {R}^{T} v & ( 36 a ) \\ subject to v \geq h . & ( 36 b )\end{matrix}$$

Empirical Evaluations

In the following empirical evaluations, the online setup used in was adopted, where tasks are observed continuously and each method is permitted to observe every data sample only once.

As for the neural network architecture, an architecture similar to the one used in is used. It is a single head fully-connected neural network with two hidden layers of size 100, a 28×28 input layer, and an output layer with 10 units. The hidden layers use ReLu activation function, and SGD is used minimize the softmax cross-entropy on the online training data.

Datasets

The evaluation is performed on MNIST Permutations (mnistP) dataset, which is a variation of MNIST, where each task contains a fixed permutation of the MNIST's input pixels. MNIST Rotations (mnistR) is another continual learning variant of MNIST where the MNIST images are rotated by a fixed angle between 0 and 180 degrees for each task. Permuted Fashion-MNIST (fashionP) and Permuted notMNIST (notmnistP) datasets share the same format of MNIST but contain images of ZALANDO's clothing products and letters, respectively.

Discrimination Metrics

The performance of the CL methods is measured trough Learning Accuracy (LA) that is the average accuracy on each tasks' test data directly after learning that task. Retained Accuracy (RA) is the average accuracy on all tasks, after the training on the last task. Backward Transfer of Information (BTI) is the difference between the learning accuracy and the retained accuracy. More formally, LA and RA are defined as follows:

$$L A = \frac{1}{T} {\sum }_{i = 1}^{T} {a}_{i , i} , RA = \frac{1}{T} {\sum }_{i = 1}^{T} {a}_{T , i} , \qquad ( 37 )$$

where a_{j,i} is the accuracy on the ith task after training on the jth task.

Comparison Protocol

In the framework, improvement of the performance of continual learning methods by showing how modular relatedness to previous tasks can be exploited to prevent catastrophic forgetting is discussed. To verify this, extensions of the methods taken from two different families of continual learning is evaluated. The first extension ModEWC, modifies EWC as a regularization-based method. The second method is ModGEM which alters GEM as a representative of gradient-based methods. The performance of the two proposed methods against that of their original methods is compared. To assure a fair comparison, the following begins with grid-based hyperparameter search for each of the methods on each of the datasets using a sample of 5 tasks and 300 samples per task. For EWC, the two parameters are tuned, the learning rate lr∈{0.001, 0.003, 0.01, 0.03, 0.1, 0.3, 1.0} and the memory strength ms∈{1, 3, 10, 30, 100, 300, 1000, 3000, 10000, 30000}. For GEM, the parameters are searched for, the learning rate lr∈{0.001, 0.003, 0.01, 0.03, 0.1, 0.3, 1.0} and the margin mg∈{0.0, 0.1, 0.5, 1.0}. The found parameters are reported as follows:

EWC found hyperparameters: lr∈{0.001, 0.003 (notmnistP), 0.01 (mnistR, mnistP, fashionP), 0.03, 0.1, 0.3, 1.0} and ms∈{1 (notmnistP), 3 (mnistR), 10, 30, 100 (mnistP, fashionP), 300, 1000, 3000, 10000, 30000}. GEM found hyperparameters: lr∈{0.001, 0.003, 0.01 (notmnistP, mnistR, mnistP, fashionP), 0.03, 0.1, 0.3, 1.0} and mg∈{0.0 (notmnistP,mnistR, mnistP, fashionP), 0.1, 0.5, 1.0}.

Without any further tuning, the same found parameter to the proposed modification is adopted, except for the memory strength, in ModEWC, that is forced to be less than 10. In all the following experiments, a stream of ten tasks is employed, where a sequence of only 1000 samples is observed from each task. Every time and evaluation is performed on a task, it is done on its test data of 10,000 samples.

Comparing Modular Relatedness Versus EWC and GEM

In this, a comparison is performed at first ModEWC versus EWC, under the aforementioned online setting with the restricted memory budget of ten samples per task. Table 3 shows below how the present invention improves retained accuracy by 20% on the fashionP dataset, and around 6% and 4% for the notmnistP and mnistP, respectively. ModEWC also performs better than EWC on mnistR without a significant difference. In terms of learning accuracy, both methods perform comparatively similar on notmnistP and mnistR, whereas, ModEWC shows substantial improvement of the learning accuracy on fashionP and mnistP. This is a clear sign of a missing forward transfer that EWC fails to achieve under the circumstances of limited memory compared to ModEWC. The gain in both LA and RA that the modification causes to EWC is accompanied by a better backward transfer (BTI) on all data sets.

TABLE 3
Comparison of performance results between Mod-EWC and EWC
in terms of LA, RA, and BTI on notmnistP, mnistR, mnistP,
and fashionP over 10 tasks with a memory budget of 10 samples
per task. The results are averaged over ten iterations with
different seeds. Each number between parentheses is the standard
error of the mean computed in the previous row.

| Data | Method | RA | LA | BTI |
|---|---|---|---|---|
| notmnistP | EWC | 68.65 | 80.98 | −12.33 |
| | | (0.28) | (0.13) | (0.21) |
| | ModEWC | 72.31 | 79.46 | −07.15 |
| | | (0.3) | (0.1) | (0.21) |
| fashionP | EWC | 42.24 | 56.24 | −14.0 |
| | | (2.14) | (1.4) | (0.81) |
| | ModEWC | 62.47 | 66.64 | −4.17 |
| | | (0.31) | (0.12) | (0.28) |
| mnistR | EWC | 62.1 | 85.56 | −23.46 |
| | | (0.26) | (0.07) | (0.27) |
| | ModEWC | 62.85 | 83.62 | −20.77 |
| | | (0.19) | (0.07) | (0.18) |
| mnistP | EWC | 66.1 | 76.95 | −10.85 |
| | | (1.9) | (0.65) | (1.25) |
| | ModEWC | 71.82 | 80.78 | −8.96 |
| | | (0.24) | (0.07) | (0.24) |

Second, a comparison is performed between ModGEM versus GEM using the same setting used in the previous experiment, online and a memory budget of ten samples per task. Table 4 also shows that ModGEM outperforms GEM on each of notmnistP, mnistP and fashionP with margins of 4%, 4%, and 2% retained accuracy, respectively. The only exception here is mnistR, where GEM is only 1.6% better than ModGEM. Both methods have relatively the same learning accuracy, which results in a better backward performance achieved by ModGEM.

TABLE 4
Comparison of performance results between Mod-GEM and GEM
in terms of LA, RA, and BTI on notmnistP, mnistR, mnistP,
and fashionP over 10 tasks with a memory budget of 10 samples
per task. The results are averaged over ten iterations with
different seeds. Each number between parentheses is the standard
error of the mean computed in the previous row.

| Data | Method | RA | LA | BTI |
|---|---|---|---|---|
| notmnistP | GEM | 64.2 | 78.6 | −14.36 |
| | | (0.4) | (0.1) | (0.4) |
| | ModGEM | 68.41 | 80.51 | −12.1 |
| | | (0.2) | (0.1) | (0.2) |
| fashionP | GEM | 56.86 | 67.4 | −10.54 |
| | | (0.18) | (0.1) | (0.17) |
| | ModGEM | 58.47 | 67.52 | −9.05 |
| | | (0.14) | (0.06) | (0.15) |
| mnistR | GEM | 75.75 | 85.05 | −9.3 |
| | | (0.2) | (0.07) | (0.21) |
| | ModGEM | 74.15 | 85.19 | −11.04 |
| | | (0.22) | (0.06) | (0.19) |
| mnistP | GEM | 64.4 | 80.38 | −15.97 |
| | | (0.25) | (0.07) | (0.26) |
| | ModGEM | 68.57 | 80.37 | −11.8 |
| | | (0.14) | (0.11) | (0.12) |

Modular Relatedness Under Different Memory Constraints

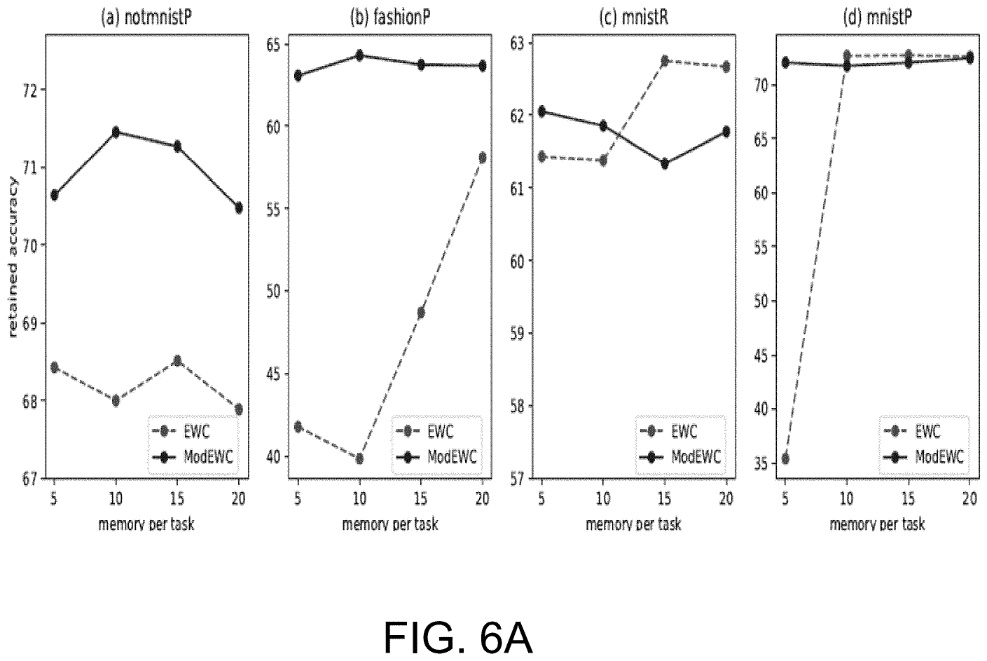

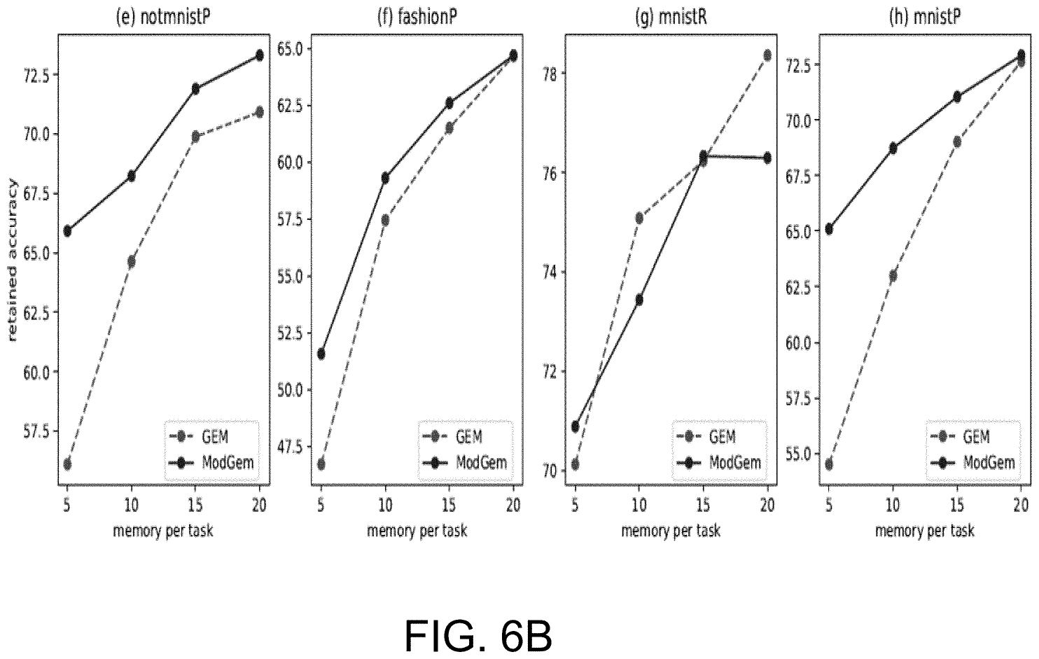

In the previous, the restrictive setting of ten samples per task for the memory is used in each of EWC and GEM. In the below, the effect of different memory budgets on the retained accuracy of both EWC, GEM, and the present invention is evaluated. The experiments are performed on the same data sets and setting used previously except varying the memory size from the set {5; 10; 15; 20}. Again, all results computed in this experiment are averaged over ten random iterations. This will be shown in FIGS. 6A and 6B.

FIGS. 6A and 6B show a graphical representation of the retained accuracy performance curves for ModEWC, ModGEM, and their original methods EWC and GEM. The curves are computed when the memory budget is taken from the set {5, 10, 15, 20}. In other words, FIGS. 6A and 6B depict the retained accuracy curves versus the memory budget in the x-axis. FIG. 6A shows how the curves of ModEWC, most of the time, dominate those of EWC and with a large margin. There is, sometimes, the trend for EWC to improve when more memory is granted, and its curve does meet with that of ModEWC on the mnistP data. This result indeed confirms the intuition that the modular-relatedness plays the role of an augmented memory when memory budget is scarce, moreover, ModEWC seems to offer an empirical upper bound of what EWC can achieve, as confirmed on notmnistP, fashion and PmnistP. Interestingly, no clear pattern can be deduced from (c) mnistR since the difference between the two curves does not exceed 1%.

FIG. 6B shows similar results when comparing ModGEM with GEM. Again and on all data sets except for mnistR, ModGEM's performance presents an upper bound of what GEM can achieve when the budget for the memory increases.

Sensitivity Analysis on the Number of Groups

The present invention presents a sensitivity analysis on the number of groups generated in ModEWC by trying the different numbers of groups, i.e., K_{d}∈{5, 10, 15, 20} for all d. Table 5 depicts an almost monotone increasing performance with a larger number of groups. The slope of this trend is, however, very small which can be interpreted as insensitivity of the proposed method towards K_{d}.

TABLE 5
Retained accuracy for ModEWC when a different number of groups
is used. Results are averaged over five iterations with
different seeds. Each number between parentheses is the
standard error of the mean computed in the previous row.

| Data | 5 | 10 | 15 | 20 |
|---|---|---|---|---|
| notmnistP | 71.0 | 71.27 | 71.01 | 71.45 |
| | (0.65) | (0.65) | (0.61) | (0.66) |
| fashionP | 63.16 | 63.2 | 63.62 | 64.306 |
| | (0.55) | (0.45) | (0.48) | (0.57) |
| mnistR | 61.43 | 61.02 | 61.63 | 61.85 |
| | (0.36) | (0.5) | (0.35) | (0.32) |
| mnistP | 71.91 | 72.34 | 72.08 | 71.78 |
| | (0.65) | (0.45) | (0.61) | (0.62) |

TABLE 6
EWCDiffNumGroups

| Data | ModEWC | RandEWC | ModGEM | RandGEM |
|---|---|---|---|---|
| notmnistP | 71.45 | 71.45 | 68.23 | 69.19 |
| | (0.66) | (0.59) | (0.44) | (0.42) |
| fashionP | 64.31 | 63.92 | 59.3 | 59.096 |
| | (0.566) | (0.55) | (0.31) | (0.27) |
| mnistR | 61.85 | 61.34 | 73.44 | 73.162 |
| | (0.32) | (0.41) | (0.31) | (0.36) |
| mnistP | 71.78 | 72.31 | 68.74 | 68.2 |
| | (0.624) | (0.47) | (0.29) | (0.17) |

In each of the embodiments described, the embodiments may include one or more computer entities (e.g., systems, user interfaces, computing apparatus, devices, servers, special-purpose computers, smartphones, tablets or computers configured to perform functions specified herein) comprising one or more processors and memory. The processors can include one or more distinct processors, each having one or more cores, and access to memory. Each of the distinct processors can have the same or different structure. The processors can include one or more central processing units (CPUs), one or more graphics processing units (GPUs), circuitry (e.g., application specific integrated circuits (ASICs)), digital signal processors (DSPs), and the like. The processors can be mounted to a common substrate or to multiple different substrates. Processors are configured to perform a certain function, method, or operation (e.g., are configured to provide for performance of a function, method, or operation) at least when one of the one or more of the distinct processors is capable of performing operations embodying the function, method, or operation. Processors can perform operations embodying the function, method, or operation by, for example, executing code (e.g., interpreting scripts) stored on memory and/or trafficking data through one or more ASICs. Processors can be configured to perform, automatically, any and all functions, methods, and operations disclosed herein. Therefore, processors can be configured to implement any of (e.g., all) the protocols, devices, mechanisms, systems, and methods described herein. For example, when the present disclosure states that a method or device performs operation or task “X” (or that task “X” is performed), such a statement should be understood to disclose that processor is configured to perform task “X”.

Each of the computer entities can include memory. Memory can include volatile memory, non-volatile memory, and any other medium capable of storing data. Each of the volatile memory, non-volatile memory, and any other type of memory can include multiple different memory devices, located at multiple distinct locations and each having a different structure. Memory can include remotely hosted (e.g., cloud) storage. Examples of memory include a non-transitory computer-readable media such as RAM, ROM, flash memory, EEPROM, any kind of optical storage disk such as a DVD, magnetic storage, holographic storage, a HDD, a SSD, any medium that can be used to store program code in the form of instructions or data structures, and the like. Any and all of the methods, functions, and operations described in the present application can be fully embodied in the form of tangible and/or non-transitory machine-readable code (e.g., interpretable scripts) saved in memory.

Each of the computer entities can include input-output devices. Input-output devices can include any component for trafficking data such as ports, antennas (i.e., transceivers), printed conductive paths, and the like. Input-output devices can enable wired communication via USB®, DisplayPort®, HDMI®, Ethernet, and the like. Input-output devices can enable electronic, optical, magnetic, and holographic, communication with suitable memory. Input-output devices can enable wireless communication via WiFi®, Bluetooth®, cellular (e.g., LTE®, CDMA®, GSM®, WiMax®, NFC®), GPS, and the like. Input-output devices can include wired and/or wireless communication pathways.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for modular-based techniques for continual learning applications, the method comprising:
training a neural network based on learning a plurality of parameters associated with the neural network using input data associated with a current task, wherein the neural network comprises a plurality of layers, and wherein a first layer, of the plurality of layers, comprises a plurality of nodes; and
performing modularization of the neural network to group the plurality of nodes of the first layer into at least two separate groups.

2. The method according to claim 1, wherein performing the modularization of the neural network is based on using an expectation-maximization algorithm.

3. The method according to claim 1, wherein performing the modularization of the neural network is based on clustering using a covariance matrix.

4. The method according to claim 1, further comprising:
performing relatedness computation based on computing a relatedness associated with the at least two separate groups of the plurality of nodes; and
providing an update signal to update the neural network for a next batch of data associated with a new task.

5. The method according to claim 4, wherein computing the relatedness comprises determining, for each group of the at least two separate groups, one or more discrepancies between conditional distributions of the current task and a plurality of previous tasks, and
wherein providing the update signal comprises generating the update signal based on employing the one or more determined discrepancies for training on a next batch of data associated with the new task.

6. The method according to claim 4, wherein performing the relatedness computation is based on weighing parameters of one or more subsequent tasks inversely proportion to a distance associated with a similarity of the current task on the plurality of nodes.

7. The method according to claim 4, wherein the current task comprises a current route used by a plurality of public transportation vehicles and the new task comprises a new route to be used by the plurality of public transportation vehicles,
wherein the input data comprises a plurality of demands of use for transport of the current route, and
wherein performing the modularization of the neural network comprises performing the modularization of the neural network such to promote transfer of the plurality of nodes from the current route to the new route.

8. The method according to claim 4, wherein the current task is a prediction of a time for preventative maintenance of a vehicle, and
wherein the input data is collected from on-board equipment on the vehicle and comprises: a distance that the vehicle has driven, an amount of time that the vehicle has driven, status of internal sensors, and measurements of the internal sensors.

9. The method according to claim 4, wherein computing the relatedness associated with the at least two separate groups of the plurality of nodes is based on one or more parameters of previously trained neural networks and subsamples of data from one or more previous tasks.

10. The method according to claim 1, wherein the neural network is an Elastic Weight Consolidation (EWC) neural network, and
wherein performing modularization of the neural network comprises performing modularization of the EWC neural network.

11. The method according to claim 1, wherein the neural network is a Gradient Episodic Memory (GEM) neural network, and
wherein performing modularization of the neural network comprises performing modularization of the GEM neural network.

12. A system comprising one or more processors which, alone or in combination, are configured to provide for execution of a method comprising:
training a neural network based on learning a plurality of parameters associated with the neural network using input data associated with a current task, wherein the neural network comprises a plurality of layers, and wherein a first layer, of the plurality of layers, comprises a plurality of nodes; and
performing modularization of the neural network to group the plurality of nodes of the first layer into at least two separate groups.

13. The system of claim 12, wherein the one or more processors are configured to provide for execution of the method further comprising:
performing relatedness computation based on computing a relatedness associated with the at least two separate groups of the plurality of nodes; and
providing an update signal to update the neural network for a next batch of data associated with a new task.

14. The system of claim 13, wherein computing the relatedness comprises determining, for each group of the at least two separate groups, one or more discrepancies between conditional distributions of the current task and a plurality of previous tasks, and
wherein providing the update signal comprises generating the update signal based on employing the one or more determined discrepancies for training on a next batch of data associated with the new task.

15. A tangible, non-transitory computer-readable medium having instructions thereon which, upon being executed by one or more processors, alone or in combination, provide for execution of a method comprising:
training a neural network based on learning a plurality of parameters associated with the neural network using input data associated with a current task, wherein the neural network comprises a plurality of layers, and wherein a first layer, of the plurality of layers, comprises a plurality of nodes; and
performing modularization of the neural network to group the plurality of nodes of the first layer into at least two separate groups.
